(19) United States
(12) Patent Application Publication
(10) Pub. No.: US 2025/0351127 A1
(43) Pub. Date: Nov. 13, 2025

(54) System and method for CBG based multiple slot transmission

(71) Applicant: ZTE CORPORATION, Shenzhen, Guangdong (CN)

(72) Inventors: Xiaoying MA, Shenzhen, Guangdong (CN); Jun XU, Shenzhen, Guangdong (CN); Bo DAI, Shenzhen, Guangdong (CN); Mengzhu CHEN, Shenzhen, Guangdong (CN); Jianqiang DAI, Shenzhen, Guangdong (CN); Hong TANG, Shenzhen, Guangdong (CN); Jiajun XU, Shenzhen, Guangdong (CN)

(21) Appl. No.: 18/868,734

(22) PCT Filed: Sep. 29, 2022
(86) PCT No.: PCT/CN2022/122952

§ 371 Date: Nov. 23, 2024

(51) Int. Cl. H04W 72/0446; H04W 72/23

(52) U.S. Cl. CPC H04W 72/0446; H04W 72/23

(57) ABSTRACT

A wireless communication method is disclosed. The method comprises receiving, by a wireless communication terminal from a wireless communication node, configuration signaling comprising configuration information for a transmission block, TB, transmitted over multiple slots; receiving, by the wireless communication terminal from the wireless communication node, control signaling comprising a code block group, CBG, information indication; and receiving, by the wireless communication terminal from the wireless communication node, the TB according to the configuration information and the CBG information indication.

### CROSS-REFERENCE TO RELATED APPLICATIONS

This application is a national phase of International Application No. PCT/CN2022/122952, with an international filing date of filed Sep. 29, 2022, the entire contents of all of which are incorporated herein by reference.

### TECHNICAL FIELD

This document is directed generally to wireless communications, and in particular to a system and method for CBG (code block group) based multiple slot transmission.

### BACKGROUND

With the development of wireless communication technology, the transmission rate, delay, throughput, reliability and other performance indexes of wireless communication system have been greatly improved by using high frequency band, large bandwidth, multi-antenna and other technologies. eXtended Reality (XR) and Cloud Gaming are some of the most important 5G media applications under consideration in the industry. XR includes representative forms such as Augmented Reality (AR), Mixed Reality (MR) and Virtual Reality (VR) and the areas interpolated among them. The traffic of XR includes video, audio, pose/control, etc. The 5G services (e.g., XR and Cloud Gaming service) need high reliability, high throughput and low latency. The video traffic also may have a large packet size and may need multiple slots for transmission.

### SUMMARY

This document relates to methods, systems, and devices for CBG based multiple slot transmission.

One aspect of the present disclosure relates to a wireless communication method. In an embodiment, the wireless communication method includes: receiving, by a wireless communication terminal from a wireless communication node, configuration signaling comprising configuration information for a transmission block, TB, transmitted over multiple slots; receiving, by the wireless communication terminal from the wireless communication node, control signaling comprising a code block group, CBG, information indication; and receiving, by the wireless communication terminal from the wireless communication node, the TB according to the configuration information and the CBG information indication.

Another aspect of the present disclosure relates to a wireless communication method. In an embodiment, the wireless communication method includes: transmitting, by a wireless communication node to a wireless communication terminal, configuration signaling comprising configuration information for a transmission block, TB, transmitted over multiple slots; transmitting, by the wireless communication node to the wireless communication terminal, control signaling comprising a code block group, CBG, information indication; and transmitting, by the wireless communication node to the wireless communication terminal, the TB in response to the configuration information and the CBG information indication.

Another aspect of the present disclosure relates to a wireless communication terminal. In an embodiment, the wireless communication terminal includes a transceiver and a processor. The processor is configured to: receive, via the transceiver from a wireless communication node, configuration signaling comprising configuration information for a transmission block, TB, transmitted over multiple slots; receive, via the transceiver from the wireless communication node, control signaling comprising a code block group, CBG, information indication; and receive, via the transceiver from the wireless communication node, the TB according to the configuration information and the CBG information indication.

Another aspect of the present disclosure relates to a wireless communication node. In an embodiment, the wireless communication node includes a transceiver and a processor. The processor is configured to: transmit, via the transceiver to a wireless communication terminal, configuration signaling comprising configuration information for a transmission block, TB, transmitted over multiple slots; transmit, via the transceiver to the wireless communication terminal, control signaling comprising a code block group, CBG, information indication; and transmit, via the transceiver to the wireless communication terminal, the TB in response to the configuration information and the CBG information indication.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWING(S)

FIGS. 1 to 5 show schematic diagrams of CBG based multiple slot transmission according to embodiments of the present disclosure.

FIG. 6 shows an example of a schematic diagram of a wireless terminal according to an embodiment of the present disclosure.

FIG. 7 shows an example of a schematic diagram of a wireless network node according to an embodiment of the present disclosure.

FIG. 8 shows a schematic diagram of CBG based multiple slot transmission according to an embodiment of the present disclosure.

FIGS. 9 to 10 show flowcharts of methods according to some embodiments of the present disclosure.

### DETAILED DESCRIPTION

### Code Block Group (CBG)

If a UE is provided with a high layer signaling PDSCH-CodeBlockGroup Transmission for a serving cell, the UE receives a PDSCH scheduled by DCI format 1_1, that includes code block groups (CBGs) of a transport block (TB).

A high layer signaling maxCodeBlockGroupsPerTransportBlock indicating a maximum number of CBGs of a TB. The UE determines the number of CBGs (M) according to the number of CBs (C) of a TB and the maximum number of CBGs (N) of a TB. M=min(C, N). The UE determines the number of CBs per CBG according to the following:

Define

$${M}_{1} = mod ( C , M ) , {K}_{1} = ⌈ \frac{C}{M} ⌉ , and {K}_{2} = ⌊ \frac{C}{M} ⌋ .$$

If M₁>0, CBG m, m=0, 1, . . . , M₁−1, consists of code blocks with indices m·K₁+k,k=0, 1, . . . , K₁−1. CBG m, m=M₁, M₁+1, . . . , M−1, consists of code blocks with indices M₁·K₁+(m−M₁)·K₂+k, k=0, 1, . . . , K₂−1.

The UE generates N bit HARQ-ACK (Hybrid Automatic Repeat Request Acknowledged) information bits for a transport block reception for the serving cell. The UE generates an ACK for the HARQ-ACK information bit of a CBG if the UE correctly received all code blocks of the CBG and generates a NACK (negative acknowledged) for the HARQ-ACK information bit of a CBG if the UE incorrectly received at least one code block of the CBG. If the number of CBGs is smaller than N, the UE generates NACK for the rest bit information.

If the UE generates a HARQ-ACK codebook in response to a retransmission of a transport block, corresponding to a same HARQ process as a previous transmission of the transport block, the UE generates an ACK for each CBG that the UE correctly decoded in a previous transmission of the transport block.

The ‘CBG transmission information’ (CBGTI) field of DCI format 1_1 is of length N_{TB}·N bits, where N_{TB} is the number of TBs provided by a high layer signaling maxNrofCodeWordsScheduledByDCI, and N is a maximum number of CBGs of a TB.
For the initial transmission of a TB as indicated by the ‘New Data Indicator’ field of the scheduling DCI, the UE may assume that all the code block groups of the TB are present.
For a retransmission of a TB as indicated by the ‘New Data Indicator’ field of the scheduling DCI, the UE may assume that the ‘CBGTI’ field of the scheduling DCI indicates which CBGs of the TB are present in the transmission. A bit value of ‘0’ in the CBGTI field indicates that the corresponding CBG is not transmitted and ‘1’ indicates that it is transmitted.

Accordingly, CBG based transmission can reduce the number of CBs which should be retransmitted, and thus improve resource utilization.

However, in some approaches, CBG based transmission can be only used for one slot transmission. One downlink (DL) TB cannot be transmitted over multiple slots. In some embodiments of this disclosure, a CBG based multiple slots transmission scheme is provided. For large packet size traffic, this scheme can reduce DCI signaling overhead and reduce retransmission resource.

To reduce the Downlink Control Information (DCI) signal overhead, one DCI scheduling PDSCH over multiple slots can be considered. In order to achieve fast retransmission, use of a code block group (CBG) can also be considered. CBG based multiple slots transmission or CBG based TB transmission over multiple slots means one DCI scheduling PDSCH over multiple slots and use CBG based transmission.

In an embodiment, the UE receives configuration information (e.g., high layer signaling), the high layer signaling indicates a maximum number of CBGs of a TB. In some embodiments, the TB is transmitted by multiple slots.

In an embodiment, the UE receives a control signaling (e.g., DCI), the control signaling includes at least a CBG information indication.

In an embodiment, the UE receives a PDSCH (e.g., the TB) according to the CBG transmission indication.

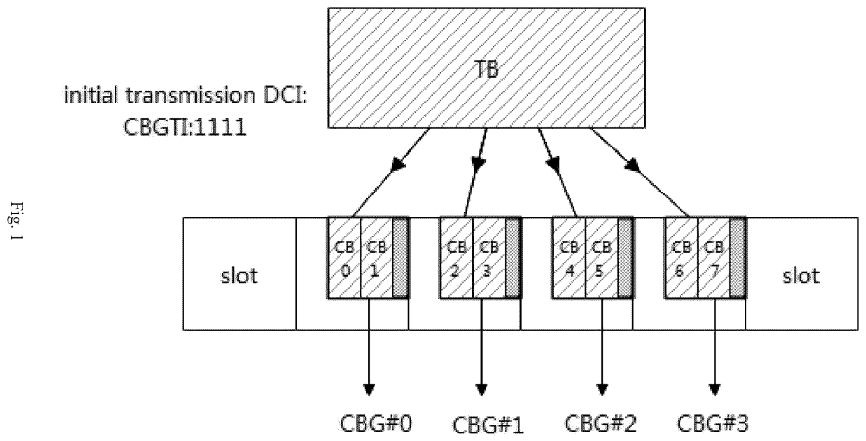

As shown in the embodiment of FIG. 1, a TB is transmitted over multiple slots, each slot transmits a CBG. In this example, one CBG includes two code blocks (CBs). the time and frequency resource for each slot is same. The number of slots which transmit the TB is indicated by a DCI. In this example, CBGTI indicates ‘1111’ which means one TB is transmitted over 4 CBGs and 4 slots.

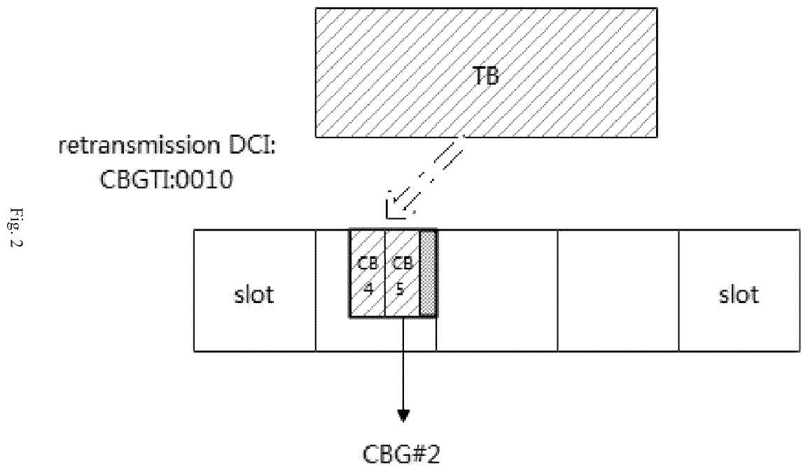

If, as shown in the embodiment of FIG. 2, the HARQ-ACK bit information for the TB is ‘1101’, which means CBG #0, 1, 3 are correctly decoded and CBG #2 is incorrectly received. In retransmission, a retransmission DCI indicates CBGTI ‘0010’, which means the CBG #2 is re-transmitted. Then only the CBs in CBG #2 are re-transmitted.

### High Layer Signaling

In some embodiments, high layer signaling may be an RRC (Radio Resource Control) signaling or a MAC (Medium Access Control) CE (Control Element) signaling.

In some embodiments, high layer signaling indicates at least one of the following: a maximum number of CBGs of a TB, a maximum number of CBGs of a TB transmitted by (or over) multiple slots, a maximum number of slots of a TB using CBG transmission and being transmitted by multiple slots, an enable indication for CBG based multiple slots transmission, an enable indication for dynamic adjust the number of HARQ-ACK bit, an enable indication for transmit one TB over multiple slots, an enable indication for CBG transmission, a maximum number of CBGs in one slot, a number of CBGs of a TB, a number of slots of a TB transmitted over multiple slots, a number of CBGs in one slot.

A maximum number of CBGs of a TB. In some embodiments, this signaling is reusing the high layer signaling maxCodeBlockGroupsPerTransportBlock. The signaling indicates a maximum number of CBGs of a TB. If another high layer signaling indicates an enable indication for transmitting one TB over multiple slots, then, CBG based multiple slots transmission is enabled.

An enable indication for CBG transmission. In some embodiments, this signaling is reusing the high layer signaling PDSCH-CodeBlockGroupTransmission. The signaling indicates CBG based transmission is enabled. If another high layer signaling also indicates enable indication for transmitting one TB over multiple slots, then, CBG based multiple slots transmission is enabled.

In some embodiments, there may be two types of high layer signaling: one enabling CBG based transmission (the TB using CBG transmission can only be transmitted in one slot), and the other enabling TB transmitted by multiple slots (CBG based multiple slot transmission is enabled). The CBG based multiple slot transmission may be a TB transmitted over multiple slots and using CBG transmission.

In some embodiments, a high layer signaling may indicate at least one of a maximum number of CBGs of a TB transmitted by multiple slots or a maximum number of slots of a TB using CBG transmission and being transmitted by multiple slots. If the high layer signaling is configured, the CBG based multiple slot transmission is enabled. The number of CBGs or slots not larger than the indication.

In some embodiments, a high layer signaling may indicate at least an enable indication for CBG based multiple slot transmission. In some embodiments, if the high layer signaling is configured, CBG based multiple slot transmission is enabled. In some embodiments, another signaling indicates a maximum number of CBGs of a TB. The number of CBGs of a TB transmitted by multiple slots may not be larger than the indication value.

In some embodiments, a high layer signaling may indicate at least an enable indication for dynamic adjustment of the number of a HARQ-ACK bit. The number of HARQ-ACK bit information for a CBG based transmission can be dynamically adjusted by the number of CBGs of a TB. In an embodiment, if the number of CBGs of a TB is 3, the number of HARQ-ACK bit information for the TB may be 3, if the number of CBGs of a TB is 1, the number of HARQ-ACK bit information for the TB is 1.

In some embodiments, a high layer signaling indicates at least a maximum number of CBGs in one slot. The number of CBGs in one slot may not be greater than the maximum number of CBGs in one slot. In some embodiments, the default value of the maximum number of CBGs in one slot is 1, if the high layer signaling is not configured.

In some embodiments, a high layer signaling indicates at least a number of CBGs of a TB. A TB is transmitted via CBGs, the number of CBGs is same as the indication value.

In some embodiments, a high layer signaling indicates at least a number of CBGs of a TB. A TB is transmitted via multiple slots, the number of slots is same as the indication value.

In some embodiments, a high layer signaling indicates at least a number of CBGs in one slot of a TB. The number of CBGs in one slot of a TB is same as the indication value.

The UE may receive a control signaling, the control signaling may include at least a CBG information indication.

### Control Signaling

In some embodiments, the control signaling may include at least a CBG information indication.

In some embodiments, the CBG information indication includes at least one of the following: a CBG transmission indication (CBGTI), an indication of a number of slots for transmitting the TB, an indication of a number of CBGs in the TB, an indication of a number of CBGs in a slot, an indication of a maximum number of CBGs in a slot, CBG flushing out information (CBGFI), or a CBG pattern indication.

CBGTI: In some embodiments, CBGTI indicates which CBG is transmitted, the indication is using a bitmap. In an embodiment, a CBGTI of ‘11100’ means that CBs in CBG #0, 1, 2 are transmitted, and CBs in CBG #3, 4 are not transmitted.

CBGFI: In some embodiments, if the ‘CBGflushing out information’ (CBGFI) field of the scheduling DCI is present, ‘CBGFI’ set to ‘0’ indicates that the earlier received instances of the same CBGs being transmitted may be corrupted, and ‘CBGFI’ set to ‘1’ indicates that the CBGs being retransmitted are combinable with the earlier received instances of the same CBGs.

Indication of a number of slots for transmitting the TB: In some embodiments, it indicates the number of slots used for one TB.

Indication of a number of CBGs in a slot: In some embodiments, a DCI indicates the number of CBGs of a slot. For one example, DCI indicates a number of CBGs of a slot, the number of CBGs in every DCI is same. For another example, DCI indicates a number of CBGs of multiple slots, different slots comprise same or different number of CBGs. In another word, DCI indicates multiple number of CBGs in one slot, each number of CBGs in one slot is for one or more slots.

In some embodiments, the control signaling is Downlink control information (DCI). In some embodiments, the control signaling is DCI format 1-1 or 1-2.

In some embodiments, the CBG information indication is indicated in one or more fields of the DCI.

In some embodiments, the field may be using an original field, and the usage of the original field is reinterpreted to a new usage. In an embodiment, a CBGTI field is reused for CBG based multiple slot transmission. If a high layer signaling indicates CBG based multiple slot transmission is enabled, the CBGTI field is used to indicate CBG transmission information over multiple slots; otherwise, the CBGTI field is used to indicate CBG transmission information in one slot.

In some embodiments, the field is a new field.

In some embodiments, different CBG information indications are indicated in different fields.

In some embodiments, the CBG information indication includes at least a CBG pattern indication. The CBG pattern indicates whether or not the CBGs are only transmitted in one slot. In an embodiment, the CBG pattern includes two patterns, one indicates that the CBGs of a TB are transmitted in one slot, another pattern indicates that the CBGs of a TB are transmitted over multiple slots. The CBG pattern indication indicates the CBG pattern used for the TB scheduled by the DCI. In an embodiment, for a CBG pattern indication including one bit, ‘0’ means that the CBGs of a TB are transmitted in one slot, and ‘1’ means that the CBGs of a TB are transmitted over multiple slots.

In some embodiments, a DCI field “Time domain resource assignment” indicates an entry which contains a number of CBGs of a TB in PDSCH-TimeDomainResourceAllocation. If a DCI indicates a number of CBGs by a “Time domain resource assignment” field, the number of CBGs is the number of CBGs of the TB to be scheduled by the DCI.

In some embodiments, a DCI field “Time domain resource assignment” indicates an entry which contains a number of slots of a TB in PDSCH-TimeDomainResourceAllocation. If a DCI indicates a number of slots by a “Time domain resource assignment” field, the number of slots is the number of slots of the TB to be scheduled by the DCI.

In some embodiments, the PDSCH-TimeDomainResourceAllocation is configured by high layer signaling. The PDSCH-TimeDomainResourceAllocation includes PDSCH-TimeDomainResourceAllocation and PDSCH-TimeDomainResourceAllocation with any suffix. A PDSCH-TimeDomainResourceAllocation includes one or more entries, each entry can be configured with a number of CBGs. DCI is used to indicates an entry of the PDSCH-TimeDomainResourceAllocation.

In some embodiments, the PDSCH-TimeDomainResourceAllocation includes one or more entries, each entry can be configured with a number of slots of a TB.

In some embodiments, the DCI which indicates a CBG based multiple slots TB transmission is scrambled by a specific RNTI. The specific RNTI is an RNTI used only for the DCI which indicates a CBG based multiple slots TB transmission.

### Determining the Number of CBGS of a TB

In this section, some determination methods of the number of CBGs of a TB is discussed.

In some embodiments, the UE determines the number of CBGs of a TB according to at least one of the following: a high layer signaling, a DCI, a number of CBs of a TB.

In some embodiments, the UE determines the number of CBGs of a TB according to at least a DCI. The DCI may indicate the number of CBGs of a TB by explicit indication or implicit indication.

In some embodiments, the number of CBGs of a TB is the minimum value among a maximum number of slots of a TB, a maximum number of CBGs of a TB, and a number of CBs of a TB. The maximum number of slots of a TB and the maximum number of CBGs of a TB are configured by high layer signaling.

In some embodiments, explicit indication means the UE directly indicates the number of CBGs of a TB in one field. The bit in the field indicates the number of CBGs of a TB.

In some embodiments, implicit indication means the number of CBGs of a TB can be deduced by another indication.

In some embodiments, the number of CBGs of a TB can be deduced by a CBGTI, wherein the number of values ‘1’ of the bits in the CBGTI is the number of CBGs of a TB. In an embodiment, a CBGTI of ‘11100’ indicates that 3 CBGs are transmitted.

In some embodiments, the number of CBGs of a TB can be deduced by a number of slots indicated by a DCI or high layer signaling. The number of CBGs may be the same as the number of slots indicated by the DCI or high layer signaling.

In some embodiments, the UE determines the number of CBGs of a TB according to at least a high layer signaling. The high layer signaling may indicate a maximum number of CBGs of a TB. If CBG based multiple slot transmission is enabled, the number of CBGs may be the same as the maximum number of CBGs of a TB configured by the high layer signaling.

In some embodiments, the UE determines the number of CBGs of a TB according to at least one of a high layer signaling, a number of CBs of a TB. In an embodiment, a high layer signaling may indicate a maximum number of slots of a TB (denoted as Smax), if the number of CBs of a TB (denoted as C) is less than the maximum number of slots of a TB configured by a high layer signaling, then the number of CBGs of the TB (denoted as M) is equal to the number of CBs of a TB; otherwise, the number of CBGs of the TB (denoted as M) is equal to a maximum number of slots of a TB (denoted as Smax). In other words, M=min{C,Smax}. min{ }means finding the minimum value.

In some embodiments, the UE determines the number of CBGs of a TB according to at least one of a high layer signaling, a number of CBs of a TB. In an embodiment, a high layer signaling may indicate a maximum number of CBGs of a TB (denoted as CBGmax), if the number of CBs of a TB (denoted as C) is less than the maximum number of CBGs of a TB configured by a high layer signaling, then the number of CBGs of the TB (denoted as M) is equal to the number of CBs of a TB; otherwise, the number of CBGs of the TB (denoted as M) is equal to a maximum number of CBGs of a TB (denoted as CBGmax). In other words, M=min{C,CBGmax}. min{ }means finding the minimum value.

### Determining the Number of Slots of a TB

In some embodiments, the UE determines the number of slots of a TB according to at least one of the following: a high layer signaling, a DCI, and/or a number of CBs of a TB.

In some embodiments, the UE determines the number of slots of a TB according to at least a DCI. The DCI may explicitly or implicitly indicate the number of slots of a TB.

In an embodiment, the DCI may have a field indicating the number of slots of a TB.

In an embodiment, the number of slots of a TB may be deduced by another indication. In an embodiment, the number of slots of a TB may be deduced by the CBGTI. The number of values ‘1’ of the CBGTI is the number of slots of a TB.

In some embodiments, the UE determines number of slots of a TB according to at least a high layer signaling. The high layer signaling may indicate the number of slots of a TB or a maximum number of slots of a TB.

In some embodiments, the UE determines the number of slots of a TB according to at least a high layer signaling and a DCI. The high layer signaling may indicate a maximum number of CBGs in one slot (denoted as CBG_oneslot), and the DCI may indicate the number of CBGs of a TB (denoted as M). The number of slots of a TB may be equal to round-up(M/CBG_oneslot).

In some embodiments, the UE determines the number of slots of a TB according to at least a number of CBGs (denoted as M) and a maximum number of slots of a TB (Smax). For example, if M<Smax, the number of slots of a TB is same as M, if M is larger than or equal to Smax, the number of slots of a TB is same as Smax. In another word, the number of slots of a TB is same as the smaller of M and Smax.

In some embodiments, the UE determines the number of slots of a TB according to at least one of a high layer signaling, a number of CBs of a TB. A high layer signaling may indicate a maximum number of slots of a TB (denoted as Smax) and a maximum number of CBGs in one slot (denoted as CBG_oneslot). The UE may determine the number of CBGs of a TB according to the method mentioned above using CBG_oneslot and a number of CBs of a TB. Then, the UE may determine the number of slots according to the method mentioned above using the number of CBGs of a TB and the maximum number of slots of a TB.

In some embodiments, the number of slots of a TB is the same as the number of CBGs of a TB. In other words, one CBG is in one slot. CBGs in one slot means the CBs in the CBG are transmitted in the slot.

### Mapping of CBGs to Slots

As discussed above, the CBGs of a TB may be transmitted over multiple slots. The following concerns how to map CBGs to slots.

In some embodiments, each CBG is transmitted in one slot.

In some embodiments, more than one CBGs are transmitted in one slot.

In some embodiments, a high layer signaling may indicate a maximum number of CBGs in one slot (denoted as CBG_oneslot). the number of CBGs of a TB is M, the number of slots of a TB (denoted as N_slot) is explicitly indicated or deduced according to the method mentioned above. The CBGs may be mapped in order and each of the first N_slot−1 slot may include CBG_oneslot CBGs, the last slot includes M−(N_slot−1)*CBG_oneslot CBGs.

In some embodiments, the number of CBGs of a TB is M, the number of slots of a TB (denoted as N_slot) is explicitly indicated or deduced according to the method mentioned above. If mod(M, N_slot)=0, each of the slot includes M/N_slot CBG.

In some embodiments, the number of CBGs of a TB is M, the number of slots of a TB (denoted as N_slot) is explicitly indicated or deduced according to the method mentioned above. If mod(M, N_slot)=0, each of the slot includes M/N_slot CBGs; if mod(M, N_slot)>0, K1=round up(M/N_slot), K2=round down(M/N_slot), define M1=mod(M, N_slot), the m^{th} slot, m=1, 2, . . . M1, consists of CBGs with indices (m−1)*K1+k, k=0, 1, . . . , K1−1. the m^{th} slot, m=M1+1, . . . , N_slot, consists of CBGs with indices M1*K1+(m−M1−1)*K2+k2, k2=0, 1, . . . , K2−1.

In some embodiments, the number of CBGs in a slot is determined by at least a time domain resource of the slot. For example, the time domain resource occupied by one CBG is predefined or indicated by certain signaling. The number of CBGs in one slot is determined by the indicated time domain resource of the slot. In another word, it depends on how many CBGs the slot's resource hold.

In some embodiments, the number of CBGs in a slot is determined by at least a number of CBGs in one slot (denoted as I). The number of CBGs in one slot may indicated by a DCI or a RRC signaling. The CBGs may be mapped in order and the last slot includes M−(N_slot−1)*I CBGs, and each of the rest of slot includes I CBGs.

In some embodiments, the number of CBGs in a slot is determined by at least a number of DL symbols in the slot. Different number of DL symbols in the slot is associate with different number of CBGs in the slot. For example, if the DL slot has less than M DL symbols, the number of CBGs in the slot is A; otherwise, the number of CBGs in the slot is B. M is an integer less than or equal to 7. In one example, A is 1 and B is 2. For another example, if the DL slot has less than M1 DL symbols, the number of CBGs in the slot is A1; if the number of DL symbols of a DL slot is less than M2 and greater than or equal to M1, the number of CBGs in the slot is A2; otherwise, the number of CBGs in the slot is B. M, M1, M2, A, B, A1, A2 are integers greater than or equal to 0 and less than 7.

In some embodiments, the number of CBGs in a slot is determined by at least a slot pattern. The slot pattern indicates the slot is a DL slot or UL slot or a S(special) slot. S slot includes both DL symbols and UL symbols. Different slot pattern can include different number of CBGs. For example, DL slot includes A CBGs, S slot includes B CBGs, UL slot includes C CBGs. In one example, A=2, B=1, C=0.

In some embodiments, the number of CBGs in a slot is determined by at least an NDI. For example, if the TB is a new data (or initial transmission), the number of CBGs in one slot is A, if the TB is a retransmission TB, the number of CBGs in one slot is B. In one example, A=2, B=1. In one example, A is greater than B.

In some embodiments, the bit sequence of a CBGs for a TB are interleaved between different CBGs or between different slots.

In some embodiments, a rate matching output sequence length for a coded block is determined according to at least a total number of coded bits available for transmission of the CBGs in a slot.

The total number of coded bits available for transmission of the CBGs in a slot is determined according to at least one of the following: MCS, a time domain resource, a frequency domain resource, a sub-TB size, a number of layers of a slot.

Denoting by E, the rate matching output sequence length for the r-th coded block, where the value of E, is determined as follows:

```
Set j = 0
for r = 0 to C − 1
  if the r -th coded block is not scheduled for transmission as indicated
  by CBGTI
  Eᵣ = 0 ;
  else
  if j ≤ C′- mod(G/(N_{L} · Qₘ), C′) − 1,
    ${E}_{r} = {N}_{L} \cdot {Q}_{m} \cdot ⌊ \frac{G}{{N}_{L} \cdot {Q}_{m} \cdot {C}^{′}} ⌋ ;$
  else
    ${E}_{r} = {N}_{L} \cdot {Q}_{m} \cdot ⌈ \frac{G}{{N}_{L} \cdot {Q}_{m} \cdot {C}^{′}} ⌉ ;$
  end if
  j = j + 1;
  end if
end for
```

where
N_{L} is the number of transmission layers that the transport block is mapped onto;
Qₘ is the modulation order;
G is the total number of coded bits available for transmission of the transport block if the TB is not transmitted over multiple slots, G is the total number of coded bits available for transmission of a slot if the TB is transmitted over multiple slots; and
C′=C if CBGTI is not present in the DCI scheduling the transport block and C′ is the number of scheduled code blocks of the transport block if CBGTI is present in the DCI scheduling the transport block. C is the number of code blocks.

### Determining the Number of CBs of a CBG

In some embodiments, the UE determines the number of CBs of a CBG according to at least one of the following: a number of CBGs of a TB, a number of CBs of a TB, a number of a slots of a TB.

In some embodiments, the UE determines the number CBs of a CBG according to the method mentioned above.

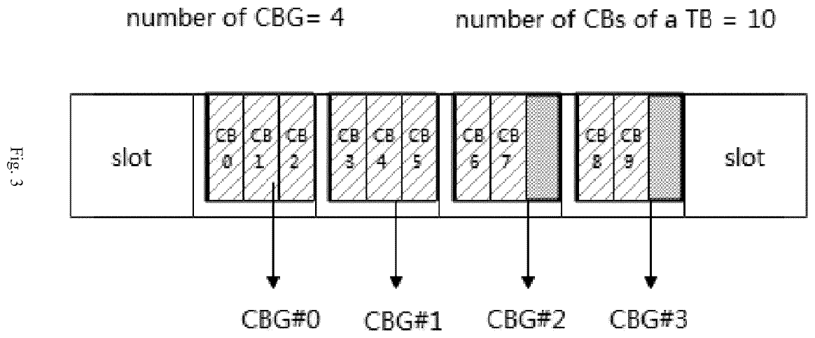

For example, as shown in the embodiment of FIG. 3, the number of CBGs may be 4, and the number of CBs may be 10. Then, the first two CBGs include 3 CBs per CBG, and the last two CBGs include 2 CBs per CBG.

In an alternative embodiment, the UE determines the number of CBs of a CBG according to at least one of the following: a number of CBGs of a TB (denoted as M), a number of CBs of a TB (denoted as C). If mod(C, M)>0, each of the first M−1 CBGs includes round-up(C/M) CBs. The last CBGs includes C−(M−1)*round-up (C/M) CBs.

In some embodiments, if mod(C, M)=0, each of the CBGs includes C/M CBs.

The mapping relationship between CBs of a TB and CBGs is discussed in this section. In some embodiments, the mapping is in order. For example, the first round-up(C/M) CBs are in the first CBG, the second round-up(C/M) CBs are in the second CBG, . . . , the last C−(M−1)*round-up(C/M) CBs are in the last CBG. The order of CBs in one CBG is in order.

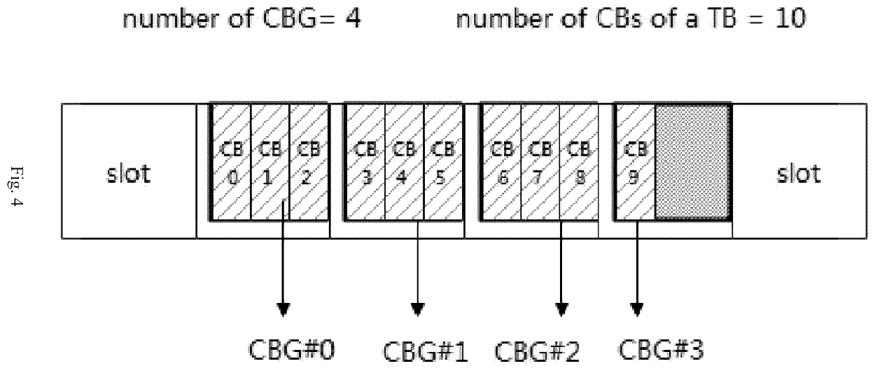

In the embodiment of FIG. 4, the number of CBGs may be 4, and the number of CBs may be 10. Then, the first three CBGs includes 3 CBs per CBG, and the last CBG includes 1 CBs.

In some embodiments, the CBs are interleaved mapping between CBGs.

### Determining the Time and Frequency Resource

In an embodiment, the time and frequency resource of the TB may be indicated by DCI.

In some embodiments, the DCI indicates a time and frequency resource of the first slot, and the time and frequency resource of the other slots are same as the time and frequency resource of the first slot. In some embodiments, the DCI indicates a time and frequency resource, the time and frequency resource is used for each slot for the TB.

In some embodiments, the DCI may indicate at least a time domain resource by a row index indicated in a Time domain resource assignment field. The indexed row defines a slot offset K₀, a start and length indicator SLIV, or directly a start symbol S and a allocation length L, and a PDSCH mapping type to be assumed in the PDSCH reception. The slot offset K₀ indicates the slot offset between the PDCCH and the first slot of PDSCH (or TB). If the DCI schedules a CBG based TB over multiple slots, the m^{th} slot of PDSCH/TB is transmitted in slot n+K₀+m−1, m=1, 2, . . . .

In some embodiments, if the slot n+K₀+m−1 is an invalid slot, the m^{th} slot of PDSCH/TB and the subsequent slot of PDSCH/TB are transmitted in order from the first valid slot after the invalid slot.

In some embodiments, if the slot n+K₀+m−1 is an invalid slot, the CBGs in m^{th} slot of PDSCH/TB are not transmitted.

In some embodiments, an invalid slot may include at least one of the following: UL slot, S slot, S slot which does not include enough time and frequency resource as indicated, DL slot which does not include enough time and frequency resource as indicated.

In some embodiments, a valid slot may include at least one of the following: DL slot, DL slot which has time and frequency resource as indicated.

In the embodiment of FIG. 5, DCI indicates a CBG based TB multiple slots transmission. CBGTI=‘1111’ means including 4 CBGs, and in this example, one CBG is in one slot. Therefore, 4 slots are used to transmit the TB. How to map the CB to CBGs has been discussed above. K₀=1 means the first slot of the PDSCH is the slot after the slot of the DCI. The other CBGs are transmitted in the subsequent valid slots after the first slot of the PDSCH for the PDSCH/TB. As shown in FIG. 5, there are two invalid slots after the slot of CBG #1, hence CBG #2 and CBG #3 are transmitted in the first two valid slots after the invalid slots.

In some embodiments, the DCI indicates at least a time domain resource by a row index indicated in Time domain resource assignment field. The indexed row defines the slot offset K₀, the start and length indicator SLIV, or the start symbol S and the allocation length L, and the PDSCH mapping type to be assumed in the PDSCH reception. The slot offset K₀ indicates the slot offset between the PDCCH and the first slot of PDSCH. If the DCI schedules a CBG based TB over multiple slots, the first slot of PDSCH/TB is transmitted in the slot n+K₀, the m^{th} slot of PDSCH/TB is transmitted in the m^{th} valid slot after the slot for the first slot of PDSCH/TB, m=2, 3, . . . .

In some embodiments, the DCI indicates at least a frequency domain resource of the PDSCH in the first slot, the frequency domain resource of the PDSCH for the other slots may be the same as the frequency domain resource of the PDSCH in first slot. In some embodiments, the DCI indicates at least a frequency domain resource of the PDSCH in one slot, each slot of the PDSCH has a same frequency domain resource. In some embodiments, the DCI indicates at least a time and frequency domain resource for a slot used to transmit the TB, each slot of the TB has a same time and frequency domain resource.

In some embodiments, the DCI indicates at least a time and frequency domain resource of a CBG.

In some embodiments, for the initial transmission, the DCI indicates a time and frequency resource of the first slot for the TB, the time and frequency resource of the other slot may be the same as the time and frequency resource of the first slot. For retransmission, the DCI indicates a time and frequency resource of the first slot for the retransmission of CBG(s). If the CBGs to be retransmitted is/are larger than one slot, the time and frequency resources of the other slot are same as the time and frequency resources of the first slot.

For retransmission CBGs, the CBGs indicated to be retransmitted is sequentially mapped to one or more slots. The order of mapping is from low to high index of the CBGs.

As discussed above, in some embodiments, different slots may include different numbers of CBs, if the time and frequency resource for each slot are same, some resources may be surplus. In some embodiments, for the surplus resource, one of the following procedures may be used:
a padding bit may be transmitted;
the bit sequence of the CBs in the same slot may be repeatedly transmitted;
some check bit may be generated and transmitted; and/or
the gNB may not transmit any bit in surplus resource for the UE.

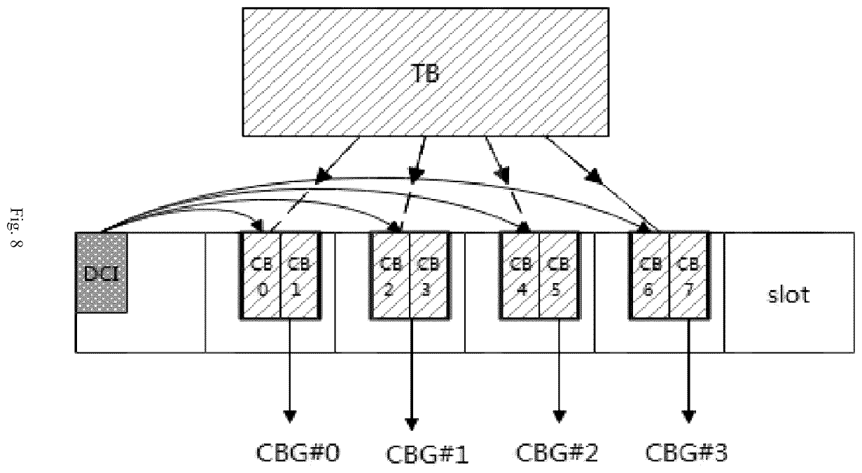

In some embodiments, as illustrated in FIG. 8, mapping the CBGs in a slot to the resource of the slot is performed in each slot which transmit a same TB. In some embodiments, mapping the CBGs in a slot to the resource of the slot is performed by rate matching procedure in each slot.

In some embodiments, as illustrated in FIG. 8, no surplus resource for the transmission.

In some embodiments, the DCI may indicate a time domain or frequency domain resource of each slot transmitting the TB.

In some embodiments, the DCI indicates a row index indicated in Time domain resource assignment field. The indexed row defines multiple sets of slot offset K₀, the start and length indicator SLIV, or the start symbol S and the allocation length L, and the PDSCH mapping type to be assumed in the PDSCH reception. Each set of slot offset K₀, the start and length indicator SLIV, or the start symbol S and the allocation length L, and the PDSCH mapping type to be assumed in the PDSCH reception may be used for one slot.

In some embodiments, the DCI indicates a row index indicated in Time domain resource assignment field. The indexed row defines a number of slots or number of CBGs of a TB and multiple sets of slot offset K₀, the start and length indicator SLIV, or the start symbol S and the allocation length L, and the PDSCH mapping type to be assumed in the PDSCH reception. The number of sets of slot offset K₀, the start and length indicator SLIV, or the start symbol S and the allocation length L, and the PDSCH mapping type to be assumed in the PDSCH reception is same as the number of slots or number of CBGs of the TB. Each set of slot offset K₀, the start and length indicator SLIV, or the start symbol S and the allocation length L, and the PDSCH mapping type to be assumed in the PDSCH reception may be used for one slot or one CBG of the TB.

In some embodiments, more than one row index are indicated in Time domain resource assignment field. Each indexed row defines a slot offset K₀, the start and length indicator SLIV, or the start symbol S and the allocation length L, and the PDSCH mapping type to be assumed in the PDSCH reception. In some embodiments, each indexed row indicates the slot offset K₀, the start and length indicator SLIV, or the start symbol S and the allocation length L, and the PDSCH mapping type to be assumed in the PDSCH reception for each slot which transmitted the TB. In some embodiments, the number of row index indicated in the field is same as the number of slots which transmitted the TB, each indexed row indicates the slot offset K₀, the start and length indicator SLIV, or the start symbol S and the allocation length L, and the PDSCH mapping type to be assumed in the PDSCH reception for one type of slot which transmitted the TB. The type of slot may include two types. The different types of slot include (or mapped to) different number of CBGs.

In some embodiments, the DCI indicates a row index indicated in Time domain resource assignment field. The indexed row defines one or two sets of slot offset K₀, the start and length indicator SLIV, or the start symbol S and the allocation length L, and the PDSCH mapping type to be assumed in the PDSCH reception. Each set of slot offset K₀, the start and length indicator SLIV, or the start symbol S and the allocation length L, and the PDSCH mapping type to be assumed in the PDSCH reception may be used for one kind of CBG. The kind of CBG is defined according to the number of CBs in one CBG. As discussed above, CBG may include one or two numbers of CBs, wherein CBGs including a first number of CBs are of a first kind, and CBGs including a second number of CBs are of a second kind.

### Other Indications

In some embodiments, the DCI may indicate a Modulation and Coding Scheme (MCS) Redundancy version (RV) and/or a HARQ process number. These indications may be the same for all CBGs/slots of one TB.

In some embodiments, the DCI may indicate multiple sets of Modulation and Coding Scheme (MCS) Redundancy version (RV) and/or a HARQ process number. Each set is used for one CBGs/slots of one TB.

In some embodiments, a DCI indicates two TBs. The bits of CBG indication information for each TB are concatenated. The slots of different TBs are different. For example, the first slot of the second TB is a slot after the last slot of the first TB. For another example, the first slot of the second TB is a valid slot after the last slot of the first TB. The bits of HARQ-ACK for the two TBs are concatenated.

In some embodiments, UE does not expect a CBG is transmitted in more than one slot.

In some embodiments, if CBG based multiple slots transmission is enabled or used. The number of CBs of the TB should be multiple of at least one of the following: number of CBGs of the TB, number of slots of the TB, modulation order of the TB, number of layers of the TB. In some embodiments, if the number of CBs of the TB calculated according to the procedures in technique specification 38.212-h10, one or more padding CBs are added to ensure the number of CBs of the TB is multiple of at least one of the following: number of CBGs of the TB, number of slots of the TB, modulation order of the TB, number of layers of the TB. The padding CBs include padding bits or repeat the bits in the CBs other than padding CBs.

In some embodiments, the total number of coded bits available for transmission of the transport block(G) can by divided by the number of CBs of the TB. In another word, the total number of coded bits available for transmission of the transport block(G) is multiple of the number of CBs of the TB.

In some embodiments, if CBG based multiple slots transmission is enabled or used. The number of CBGs of the TB should be multiple of at least the number of slots of the TB.

The restriction above is used to ensure a CBG or a CB will not be transmitted over more than one slot.

### Transport Block (TB) Size

In some embodiments, the UE determines a sub-TB size(S_TB), wherein the sub-TB size is the size determined according to at least one of the layers, the total number of allocated PRBs before rate matching, MCS, or RV of one slot. Then, the TB size is N_slot*S_TB. In some embodiments, the sub-TB size is the TB size of one slot of the TB, the TB size is N_slot*S_TB.

In some embodiments, the UE determines the total number of REs allocated for PDSCH (N_{RE}) by

$$N = min ( 156 , {N}_{RE}^{′} ) \cdot {n}_{PRB} \cdot {N}_{slot} ,$$

where nPRB is the total number of allocated PRBs for the UE,

$${N}_{RE}^{′}$$

is the number of REs allocated for PDSCH within a PRB, and Nₛₗₒₜ is the number of slots of the TB using CBG based transmission.

In some embodiments, the UE determines the total number of REs allocated for PDSCH (N_{RE}) by

$$N = min ( 156 , {N}_{RE}^{′} ) \cdot {n}_{PRB} \cdot {N}_{CBG} ,$$

where nPRB is the total number of allocated PRBs for the UE,

$${N}_{RE}^{′}$$

is the number of REs allocated for PDSCH within a PRB, and NCBG is the number of CBGs of the TB using CBG based transmission.

In some embodiments, the maximum size of a TB for the CBG based multiple slot transmission may be larger than the maximum size of a TB for the one slot transmission. One slot transmission means the TB is transmitted only in one slot.

In some embodiments, a DCI indicates at least a time and frequency domain resource of a CBG. A TB size in one CBG is as a sub-TB size, and the total TB size is calculated by the sub-TB size and the number of CBGs. The number of CBGs is configured by a high layer signaling or indicated by a DCI. For example, the total TB size is calculated by multiplying the sub-TB size by the number of CBGs.

### HARQ-ACK

In some embodiments, a high layer signaling or a control signaling may indicate enabling dynamic adjustment of the number of HARQ-ACK bits.

In some embodiments, the bit number of the HARQ-ACK for the CBG based multiple slot transmission may be the same as the number of CBGs of the TB.

In some embodiments, the DCI which schedules the CBG based multiple slot transmission may also indicate a value of K1. K1 is a slot offset between the last slot of the PDSCH and the Downlink (DL) ACK. K1 may include a value indicated by the PDSCH-to-HARQ-timing-indicator field in the DCI format.

Some embodiments of the present disclosure provide an approach towards CBG based multiple slot transmission using, e.g., determining number of CBGs of a TB, determining number of slots of a TB, how to map CBGs to slots and determining the time and frequency resources.

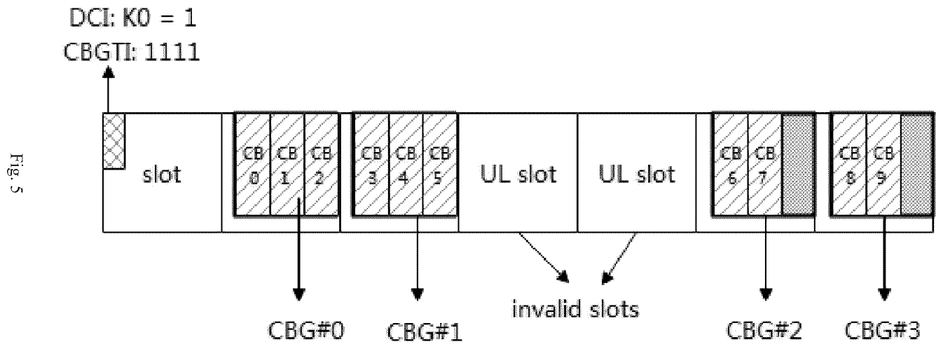

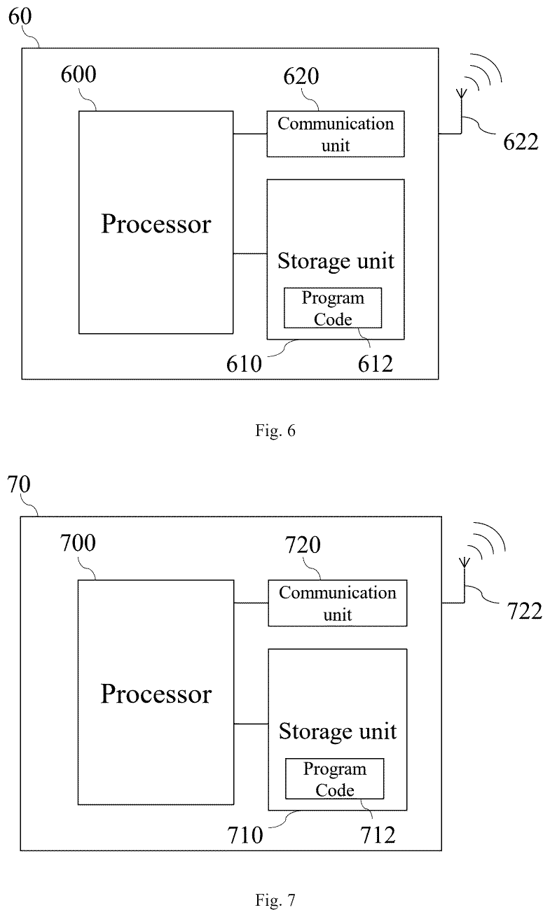

FIG. 6 relates to a schematic diagram of a wireless terminal 60 according to an embodiment of the present disclosure. The wireless terminal 60 may be a user equipment (UE), a mobile phone, a laptop, a tablet computer, an electronic book or a portable computer system and is not limited herein. The wireless terminal 60 may include a processor 600 such as a microprocessor or Application Specific Integrated Circuit (ASIC), a storage unit 610 and a communication unit 620. The storage unit 610 may be any data storage device that stores a program code 612, which is accessed and executed by the processor 600. Embodiments of the storage unit 610 include but are not limited to a subscriber identity module (SIM), read-only memory (ROM), flash memory, random-access memory (RAM), hard-disk, and optical data storage device. The communication unit 620 may a transceiver and is used to transmit and receive signals (e.g. messages or packets) according to processing results of the processor 600. In an embodiment, the communication unit 620 transmits and receives the signals via at least one antenna 622 shown in FIG. 6.

In an embodiment, the storage unit 610 and the program code 612 may be omitted and the processor 600 may include a storage unit with stored program code.

The processor 600 may implement any one of the steps in exemplified embodiments on the wireless terminal 60, e.g., by executing the program code 612.

The communication unit 620 may be a transceiver. The communication unit 620 may as an alternative or in addition be combining a transmitting unit and a receiving unit configured to transmit and to receive, respectively, signals to and from a wireless network node (e.g. a base station).

FIG. 7 relates to a schematic diagram of a wireless network node 70 according to an embodiment of the present disclosure. The wireless network node 70 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 70 may comprise (perform) at least one network function such as an access and mobility management function (AMF), a session management function (SMF), a user place function (UPF), a policy control function (PCF), an application function (AF), etc. The wireless network node 70 may include a processor 700 such as a microprocessor or ASIC, a storage unit 710 and a communication unit 720. The storage unit 710 may be any data storage device that stores a program code 712, which is accessed and executed by the processor 700. Examples of the storage unit 712 include but are not limited to a SIM, ROM, flash memory, RAM, hard-disk, and optical data storage device. The communication unit 720 may be a transceiver and is used to transmit and receive signals (e.g. messages or packets) according to processing results of the processor 700. In an example, the communication unit 720 transmits and receives the signals via at least one antenna 722 shown in FIG. 7.

In an embodiment, the storage unit 710 and the program code 712 may be omitted. The processor 700 may include a storage unit with stored program code.

The processor 700 may implement any steps described in exemplified embodiments on the wireless network node 70, e.g., via executing the program code 712.

The communication unit 720 may be a transceiver. The communication unit 720 may as an alternative or in addition be combining a transmitting unit and a receiving unit configured to transmit and to receive, respectively, signals to and from a wireless terminal (e.g. a user equipment or another wireless network node).

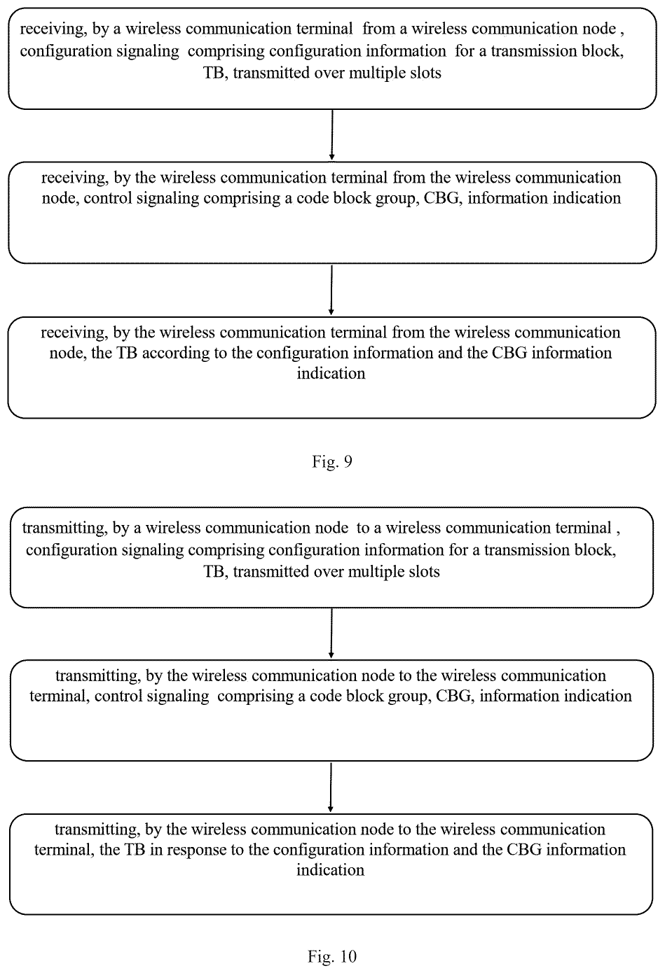

FIGS. 9 and 10 show flowcharts of methods according to an embodiment of the present disclosure.

A wireless communication method is provided according to an embodiment of the present disclosure. In an embodiment, the wireless communication method may be performed by using a wireless communication terminal (e.g., a UE). In an embodiment, the wireless communication terminal may be implemented by using the wireless network node 70 described above, but is not limited thereto.

As illustrated in FIG. 9, in an embodiment, the wireless communication method includes: receiving, by a wireless communication terminal from a wireless communication node, configuration signaling comprising configuration information for a transmission block, TB, transmitted over multiple slots; receiving, by the wireless communication terminal from the wireless communication node, control signaling comprising a code block group, CBG, information indication; and receiving, by the wireless communication terminal from the wireless communication node, the TB according to the configuration information and the CBG information indication.

Details in this regard can be ascertained with reference to the paragraphs above, and will not be repeated herein.

Another wireless communication method is provided according to an embodiment of the present disclosure. In an embodiment, the wireless communication method may be performed by using a wireless communication node (e.g., a base station). In an embodiment, the wireless communication terminal may be implemented by using the wireless communication node 70 described above, but is not limited thereto.

As illustrated in FIG. 10, in an embodiment, the wireless communication method includes: transmitting, by a wireless communication node to a wireless communication terminal, configuration signaling comprising configuration information for a transmission block, TB, transmitted over multiple slots; transmitting, by the wireless communication node to the wireless communication terminal, control signaling comprising a code block group, CBG, information indication; and transmitting, by the wireless communication node to the wireless communication terminal, the TB in response to the configuration information and the CBG information indication.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a wireless communication terminal from a wireless communication node, configuration signaling comprising configuration information for a transmission block, TB, transmitted over multiple slots;
receiving, by the wireless communication terminal from the wireless communication node, control signaling comprising a code block group, CBG, information indication; and
receiving, by the wireless communication terminal from the wireless communication node, the TB according to the configuration information and the CBG information indication.

2. (canceled)

3. The wireless communication method of claim 1, wherein the configuration information comprises at least one of:
a maximum number of CBGs of the TB transmitted over multiple slots,
a maximum number of slots of the TB transmitted over multiple slots and using a CBG based transmission,
an enable indication for transmitting the TB over multiple slots and using a CBG based transmission,
an enable indication for dynamically adjusting a number of bits of hybrid automatic repeat request acknowledgment, HARQ-ACK,
an enable indication for transmitting the TB over multiple slots,
an enable indication for transmitting the TB using a CBG transmission, or
a maximum number of CBGs in one slot.

4. The wireless communication method of claim 1, wherein the CBG information indication comprises at least one of:
a CBG transmission indication, CBGTI,
an indication of a number of slots for transmitting the TB,
an indication of a number of CBGs in the TB,
an indication of a number of CBGs in a slot,
an indication of a maximum number of CBGs in a slot,
CBG flushing out information, CBGFI, or
a CBG pattern indication.

5. (canceled)

6. The wireless communication method of claim 3, wherein the CBG pattern indication indicates whether CBGs in the TB are transmitted over multiple slots.

7. (canceled)

8. The wireless communication method of claim 1, wherein at least one of a number of CBGs in the TB or a number of slots for transmitting the TB is determined according to at least one of the configuration signaling or the control signaling.

9. (canceled)

10. The wireless communication method of claim 8, wherein the number of CBGs in the TB is determined according to a number of slots for transmitting the TB indicated in the control signaling, and the number of CBGs in the TB is the same as the number of slots for transmitting the TB.

11. The wireless communication method of claim 8, wherein the number of CBGs in the TB is deduced according to a smaller one of a maximum number of slots for transmitting the TB and a number of code blocks, CBs, in the TB.

12. The wireless communication method of claim 8, wherein the number of slots for transmitting the TB is deduced according to a maximum number of CBGs in one slot indicated in the configuration signaling and a number of CBGs in the TB indicated in the control signaling.

13. The wireless communication method of claim 8, wherein the number of slots for transmitting the TB is determined according to at least one of the configuration signaling, a CBG information indication, or a number of code blocks in the TB.

14. The wireless communication method of claim 8, wherein the number of slots for transmitting the TB is the same as the number of CBGs in the TB.

15. (canceled)

16. The wireless communication method of claim 1, wherein CBGs in the TB are transmitted over multiple slots, more than one of the CBGs are transmitted in one of the slots, and a mapping relationship between the CBGs and the slots is determined according to at least one of: a number of CBGs in one slot, a maximum number of CBGs in one of the slots denoted as CBG_oneslot, a number of CBGs in the TB denoted as M, a time domain resource of each slot, a slot pattern, a number of downlink, DL symbol in the slot, a new data indication, NDI, or a number of the slots for transmitting the TB denoted as N_slot.

17. The wireless communication method of claim 16, wherein the CBGs are mapped to the slots in order, a number of CBGs transmitted in a last one of the slots is M−(N_slot−1)*CBG_oneslot, and a number of CBGs transmitted in each of the rest slots is CBG_oneslot.

18. The wireless communication method of claim 16, wherein the CBGs are mapped to the slots in order, a number of CBGs transmitted in a last one of the slots is M−(N_slot−1)*round-up(M/N_slot), and a number of CBGs transmitted in each of the rest of slots is round-up(M/N_slot).

19. The wireless communication method of claim 17, wherein the CBGs are mapped to the slots in order, if mod(M, N_slot)>0, the mapping relationship between the CBGs and the slots follows the following equations:
$$an interger K 1 = round - up ( M / N\_slot ) ,$$
$$an interger K 2 = round - down ( M / N\_slot ) ,$$
$$an interger M 1 = mod ( M , N\_slot ) ,$$
for m=1, 2, . . . , M1, an m^{th} slot consists of CBGs with indices (m−1)*K1+k1, k1=0, 1, . . . , K1−1,
for m=M1+1, . . . , N_slot, an m^{th} slot consists of CBGs with indices M1*K1+(m−M1−1)*K2+k2, k2=0, 1, . . . , K2−1.

20. The wireless communication method of claim 1 further comprising:
interleaving bit sequence of the multiple CBGs.

21-23. (canceled)

24. The wireless communication method of claim 1, wherein the control signaling indicates a first time resource and a first frequency resource of a first slot transmitting the TB, and a second time resource and a second frequency resource of a second slot transmitting the TB are identical to the first time resource and the first frequency resource of the first slot transmitting the TB.

25. The wireless communication method of claim 1, wherein an mth slot for transmitting TB is a slot n+K0+m−1, wherein slot n indicates a slot for receiving the control signaling, K0 indicates a slot offset between the control signaling and a first slot of the TB, m is an integer between 1 and N_slot, and N_slot indicates a number of slots transmitting the TB; and
wherein CBGs of the TB in the mth slot is not transmitted in response to the slot with the index of n+K0+m−1 being an invalid slot or the CBGs of the TB in the mth slot is transmitted in a valid slot after the slot with the index of n+K0+m−1.

26-34. (canceled)

35. A wireless communication method comprising:
transmitting, by a wireless communication node to a wireless communication terminal, configuration signaling comprising configuration information for a transmission block, TB, transmitted over multiple slots;
transmitting, by the wireless communication node to the wireless communication terminal, control signaling comprising a code block group, CBG, information indication; and
transmitting, by the wireless communication node to the wireless communication terminal, the TB in response to the configuration information and the CBG information indication.

36. The wireless communication method of claim 35, further comprising: receiving, by the wireless communication node from the wireless communication terminal, an HARQ-ACK for CBGs in the TB, and a number of bits of the HARQ-ACK is a fixed value or dynamically adjusted in response to a number of CBGs in the TB.

37. A wireless communication terminal, comprising:
a transceiver; and
a processor configured to: receive, via the transceiver from a wireless communication node, configuration signaling comprising configuration information for a transmission block, TB, transmitted over multiple slots; receive, via the transceiver from the wireless communication node, control signaling comprising a code block group, CBG, information indication; and receive, via the transceiver from the wireless communication node, the TB according to the configuration information and the CBG information indication.

38-41. (canceled)
